(19) United States
(12) Patent Application Publication
(10) Pub. No.: US 2003/0175202 A1
(43) Pub. Date: Sep. 18, 2003

(54) Table salt, table sugar, and table vinegar formulations with nitrite scavengers

(76) Inventor: Hsiang-Kuen Mao, San Jose, CA (US)

Correspondence Address: Hsiang-Kuen Mao, 2800 West Pintail Way, Elk Grove, CA, 95758-8201, US

(21) Appl. No.: 10/355,520

(22) Filed: Jan. 31, 2003

(30) Foreign Application Priority Data
Feb. 5, 2002 (TW) 91102034

(51) Int. Cl. C01D 3/04

(52) U.S. Cl. 423/499.4; 423/265

(57) ABSTRACT

This invention describes formulations for table salt, table sugar and vinegar, containing nitrite scavengers to help reduce the intake of nitrosamines.

### CROSS REFERENCE TO RELATED APPLICATIONS

See accompany case, NITRITE SCAVENGING FORMULATION TO REDUCE FORMATION OF NITROSAMINES DURING CHEWING OF FOOD ITEMS SUCH AS CHEWING TOBACCO AND BETEL NUTS

Foreign priority claimed: Case filed in Taiwan on Feb. 3, 2002 with the application number of 91102034.

### STATEMENT REGARDING FEDERALLY SPONSORED RESEARCH OR DEVELOPMENT

Not applicable.

### REFERENCE TO SEQUENCE LISITING, A TABLE, OR A COMPUTER PROGRAM LISTING COMPACT DISK APPENDIX

Not applicable.

This invention describes formulations for table salt, table sugar and vinegar, containing nitrite scavengers to help reduce the intake of nitrosamines.

### BACKGROUND OF THE INVENTION

Nitrosamines are well known cancer-inducing agents. Nitrosamines are formed by the reaction of an organic amine, or an organic cyclic imine, and a nitrosating agent, i.e., a nitrite salt or nitrous acid. It is generally believed that the ability of nitrosamines to bind DNA and to alkylate the DNA bases to induce point mutation is responsible in promoting cancer. One such example is the following reaction between guanine, a DNA forming base, with N-nitrosodimethyl amine, a nitrosamine:

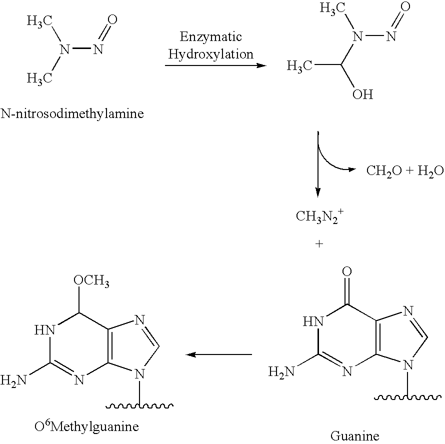

Amine compounds can be classified into primary amines, secondary amines, tertiary amines and cyclic amines (imines). Only the secondary amines and cyclic amines such as imines react with nitrosating agents to form chemically stable nitrosamines.

Primary amine derived nitrosamines are chemically unstable and decompose quickly. Tertiary amines do not form nitrosamines with nitrosating agents. The reaction of secondary amines or cyclic amines with nitrous acid, a nitrosating agent, to give nitrosamines can be represented by the following reaction formula:

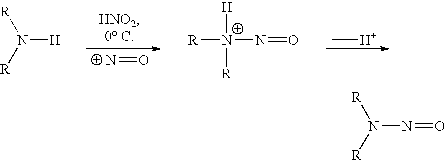

Where Rs can be normal hydrocarbon chains, cyclic chains, aromatic groups, acyclic groups, or the two R groups can be linked in a cyclic structure as in the case of an imine.

The reaction between primary amines and a nitrosating agent, nitrous acid in this case, can be given by the following reaction formula:

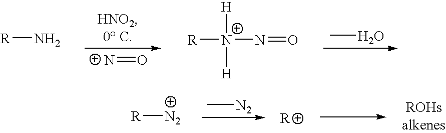

The reaction between tertiary amines and nitrosating agents give amine salts. These amine salts are not known to be cancer-inducing agents. The generally present nitrosating agents are nitrous acid and its salts. These agents are referred to as “nitrites” or “nitrosating agents” in this current writing.

The human saliva contains an appreciable amount of nitrites, the nitrosating agent. The concentration of saliva nitrites have been reported to be as high as 6 to 16 mg per liter of saliva in Analytical Sciences, 2001, 17, 495. It was reported that about 93% of total human nitrite intake came from saliva. When eating food items containing nitrosamine precursors, i.e., secondary amines and cyclic imines, the nitrosating reaction may take place to form nitrosamines. These nitrosamines may promote cancer formation in the human gastric system, i.e., oral cancer, stomach cancer, etc. With secondary or cyclic amines, the resulting nitrosamines are chemically stable, and are likely carcinogens. With primary amines, the formed nitrosamines are chemically unstable and decompose readily to form inert byproducts, as indicated by the previous chemical equation.

Nitrates are naturally present in drinking water and in food items. Nitrate ion is an essential nutrient to the human body. It has been reported that about 25% of human nitrate intake is excreted by the body into saliva and re-incorporated through gastric juice. Part of this saliva nitrate is reduced to nitrite by bacteria that are present in the mouth. Overall about 5% of the daily nitrate intake is converted into nitrites in saliva. Thus stable nitrosamine formation in the mouth during chewing or in the stomach after swallowing could take place readily if one eats food items containing secondary amines or cyclic imines. For food items that are intended for chewing, i.e. staying in the mouth for a prolonged period of time, the formation of nitrosamines tend to be exaggerated, and could account for the increased risk of oral cancer, such as the well published case with chewing tobacco usage, and the prevalent oral cancer associated with the habit of chewing betel nuts in the Far Eastern countries of Taiwan, Thailand, south part of China, and several other Southeast Asian countries.

It has been reported that antioxidants such as ascorbic acid (vitamin C) can help lower nitrosamine formation in gastric juice thus may help reduce stomach cancer formation. However, it is also known that such antioxidants, when present with nitrate, could lead to enhanced formation of nitrosating agents to encourage the formation of additional nitrosamines.

### BRIEF SUMMARY OF THE INVENTION

It is an object of the present invention to provide a formulation for removing or reducing nitrosating agents of nitrites and nitrous acid from saliva and from gastric juice, thus help reduce the formation of nitrosamines when eating food items containing nitrosamine precursors. It is believed that this reduction in nitrosamine intake could lead to better cancer prevention against oral cancers and other cancers of the digestive. It is another object of the invention to provide formulations that can be conveniently applied to most of the common food items in the form of table salt, table vinegar and table sugar.

### BRIEF DESCRIPTION OF THE SEVERAL VIEWS OF THE DRAWING

Not applicable.

### DETAILED DESCRIPTION OF THE INVENTION

This invention discovered the use of one or more nitrite scavenger additives either alone or in combination with a reducing agent in food products to remove the nitrosating agents in saliva and in gastric juice in order to prevent the formation of nitrosamines in the human digestive system. The preferred scavengers are selected from the class of primary amines and chemicals containing at least one un-substituted amino group that could form chemically unstable nitrosamines by reacting with the nitrosating agents present in human saliva. These scavengers thus help prevent the formation of chemically stable carcinogenic nitrosamines of secondary amines and cyclic imines that could be present in food items. It is believed that the added primary amines competitively react with any nitrosating agents present in saliva to form unstable nitrosamines that are then decomposed to non-carcinogenic chemicals. Thus the addition of these primary amines effectively prevents the formation of carcinogenic nitrosamines that could form from the chemical reaction of secondary amines or cyclic imines in food items with the nitrosating agent in saliva, either during chewing or after swallowing.

The preferred primary amines are those that are acceptable food additives without negative toxicity concerns, are rapidly soluble in water and in saliva, and are agreeable in taste and smell. Glucosamine and its salts are the preferred scavengers of this invention. Glucamine and its salts are also preferred. Examples of the salts include hydrochloride, sulfate, ascorbate, phosphate, acetate, lactate, glycolate, citrate, etc. When incorporating into products with high levels of moistures and extreme pHs, glucamine and its salts are preferred over glucosamine and its salts. The polymeric form of glucosamine and its acetylated derivative, chitosan and chitin, may also be used but are less preferred due to lower solubility in saliva.

Glucosamine and its salts are commonly used in health supplement products to help reduce joint pains. Glucosamine is a naturally present ingredient in human body, a key ingredient in forming the soft tissues around the joints. It is a well-known chemical with a good safety record as a health supplement active for joint pain. Glucamine is the hydrogenated glucosamine, thus is chemically more stable. Glucamine and its salts are commonly used as a pH buffer for intravenous injection medicines.

Alternatively, amides of acetic acid, formic acid, propionic acid, isopropionic acid, citric acid, lactic acid, ascorbic acid, glycolic acid, phosphoric acid, gluconic acid etc. of glucosamine or glucamine can also be used. These amides would be more mixable in oily food items. Saliva action can hydrolyze these amides to give the active primary amines.

The preferred amino-containing chemicals are amino acids. Amino acids of choice are those possessing an un-substituted amino functional group but not containing any sulfur nor sulfide functional groups. Suitable amino acids include glycine, alanine, glutamine, aspartic acid, isoleucine, leucine, lysine, serine, threonine and valine. Salts of these amino acids can also be used if desired.

It has been reported in literature that the human saliva contains from about 6 mg per liter to about 16 mg per liter of nitrites. Thus, in the case of glucosamine hydrochloride or glucamine hydrochloride, a level of about 0.00028 gram to about 0.00073 gram of a 100% active glucosamine hydrochloride or glucamine hydrochloride would be required to completely neutralize all nitrites in 10 c.c. of saliva. While not intended to be limited by theory, it is believed that the high water solubility of glucosamine or glucamine enhances its reactivity towards the soluble nitrites, thus is the preferred reactant to react with these saliva nitrites.

In practice an appropriate amount of the additives, typically sufficient to completely neutralize all nitrosating agents in 10 to 100 c.c. of saliva, should be eaten together with the food items containing nitrosamine-inducing secondary amines or cyclic imines. Some amount of reducing agents such as vitamin C, vitamin E or other common anti-oxidants could also be incorporated to protect against commonly present free radical reactions. Since it is difficult in practice to incorporate such a nitrite scavenger in all food items, particularly the fruits and vegetables, this invention devises the method of addition via incorporation of nitrite scavengers in food items that can be applied to most food. To achieve this purpose, the incorporation of one or more nitrite scavengers into common table salt, table sugar and table vinegar are chosen as the main methods of delivery of these beneficiary dietary supplements. Most of the preferred primary amines and amino acids are available in powder form, particularly in their salt form, i.e., glucosamine hydrochloride, glucamine hydrochloride, glucosamine potassium sulfate, glucamine sodium sulfate etc. These powders can be incorporated directly into other powder products such as salt and sugar. To avoid segregation, it is preferred to closely match particle size of the additive to that of the original product. This can be done by selecting larger particle additive, or to enlarge the particle size of the additive via common agglomeration methods, or by reducing the particle size of the salt or the sugar. For vinegar application, the amount of additive is limited by its solubility in vinegar. To avoid over saturation, and the possible subsequent phase separation via crystallization, the additive level should not exceed 85% of the saturation concentration.

For table salt formulation, other common additives can also be included. Examples include the iodine enrichments through the addition of potassium iodide, sodium iodide, sodium iodate, or potassium iodate; and the addition of common free flowing agents, i.e., talc, bentonites, sodium aluminosilicates, etc., to prevent caking. For table sugar formulation, some amount of free flowing agents or agglomeration agents can also be used to prevent caking or segregation.

### EXAMPLES

### Example 1

A salt formulation containing 90% NaCl, 10% D-glucosamine hydrochloride.

### Example 2

A vinegar product containing 1% added glycine.

### Example 3

What is claimed is:

1. A table salt formulation comprising salt and an effective amount of nitrite scavengers.

2. The formulation of claim 1 where the nitrite scavengers comprise of primary amines or amino acids containing at least one primary amino functional group.

3. The formulation of claim 1 further comprising one or more antioxidants.

4. The formulation of claim 1 where the salt content is at least 40% by weight, and the content of nitrite scavengers is 0.1% to 60% by weight.

5. The formulation of claim 1, further comprising iodine salts consisting essentially of sodium iodide, sodium iodate, potassium iodide, potassium, iodate, magnesium iodide, magnesium iodate, calcium iodide, and calcium iodate.

6. The formulation of claim 1, further comprising an effective amount of free flowing agents.

7. The formulation of claim 2 where the primary amines comprise of glucosamine or glucamine and the corresponding salts.

8. The formulation of claim 2 where the primary amines comprise of D-glucosamine hydrochloride, D-glucosamine sulfate, potassium and sodium salts, D-glucamine, D-glucamine hydrochloride, D-glucamine sulfate potassium and sodium salts.

9. The formulation of claim 3 where the amino acids and its salts are glycine, alanine, glutamine, aspartic acid, isoleucine, leucine, lysine, serine, threonine and valine.

10. A table sugar formulation comprising sugar and an effective amount of nitrite scavengers.

11. The formulation of claim 10 where the nitrite scavengers comprise of primary amines or amino acids containing at least one primary amino functional group.

12. The formulation of claim 10, further comprising one or more antioxidants.

13. The formulation of claim 10 where the sugar content is at least 50% by weight.

14. The formulation of claim 10 where the nitrite scavengers is 0.1% to 50% by weight.

15. The formulation of claim 10 further comprising an effective amount of free flowing agents.

16. The formulation of claim 11 where the primary amines comprise of glucosamine or glucamine and the corresponding salts.

17. The formulation of claim 11 where the primary amines comprise of D-glucosamine hydrochloride, D-glucosamine sulfate potassium and sodium salts, D-glucamine, D-glucamine hydrochloride, D-glucamine sulfate potassium and sodium salts.

18. The formulation of claim 11 where the amino acids and its salts are glycine, alanine, glutamine, aspartic acid, isoleucine, leucine, lysine, serine, threonine and valine.

19 A table vinegar formulation comprising vinegar, water, and an effective amount of nitrite scavengers.

20. The formulation of claim 19 where the nitrite scavengers comprise of primary amines and amino acids containing at least one primary amino functional group.

21. The formulation of claim 19, further comprising one or more antioxidants.

22. The formulation of claim 19 where the acetic acid content in vinegar is at least 2% by volume.

23. The formulation of claim 19 where the nitrite scavengers is 0.1% to 10% by weight.

24. The formulation of claim 20 where the primary amines comprise of glucosamine or glucamine and the corresponding salts.

25. The formulation of claim 20 where the primary amines comprise of D-glucosamine hydrochloride, D-glucosamine sulfate potassium and sodium salts, D-glucamine, D-glucamine hydrochloride, D-glucamine sulfate potassium and sodium salts.

26. The formulation of claim 20 where the amino acids and its salts are glycine, alanine, glutamine, aspartic acid, isoleucine, leucine, lysine, serine, threonine and valine.
